(19) United States
(12) Patent Application Publication
(10) Pub. No.: US 2025/0379482 A1
(43) Pub. Date: Dec. 11, 2025

(54) FUSION OF PLASTIC COMPONENTS OF THE BUSBAR AND HOUSING OF THE ELECTRIC MOTOR TEMPERATURE SENSOR

(71) Applicant: Schaeffler Technologies AG & Co. KG, Herzogenaurach (DE)

(72) Inventors: Natanael Pérez Torres, Puebla (MX); Dario Teran Larrainzar, San Martin Texmelucan (MX)

(21) Appl. No.: 18/735,700

(22) Filed: Jun. 6, 2024

(51) Int. Cl. H02K 3/50; H02K 1/16; H02K 3/28; H02K 11/25

(52) U.S. Cl. CPC H02K 3/50; H02K 1/16; H02K 3/28; H02K 11/25; H02K 2203/09

(57) ABSTRACT

A busbar may include bars, bus pins connected to the bars, a neutral bus, and an overmold. The overmold may support the bars, the bus pins, and the neutral bus. The overmold may also define hairpin housings and a temperature sensor housing. A stator may include the busbar, a temperature sensor, and a winding. The winding may be made of hairpins. The hairpin housing may house pairs of the hairpins. The temperature sensor housing may house the temperature sensor and a pair of the hairpins. The temperature sensor may abut one of the pair of the hairpins within the temperature sensor housing such that the temperature sensor may measure the temperature of the hairpins. An electric motor may include the stator and a rotor.

### TECHNICAL FIELD

The present disclosure generally relates to electrical connections between conductive members, and, more particularly, to electrical connections between busbars and hairpin windings.

### BACKGROUND

Temperature sensors are used in three-phase electric motors. The temperature sensors may measure a temperature of a stator winding within the three-phase electric motors. The temperature sensor may couple to a hairpin of the winding using a plastic component. The function of the plastic component may be to couple the temperature sensor to the hairpin. The addition of the plastic component may require additional parts and time-of-assembly for the three-phase electric motors. Therefore, it would be advantageous to provide a device, system, and method that cures the shortcomings described above.

### SUMMARY

A busbar is described, in accordance with one or more embodiments of the present disclosure. The busbar may include: a plurality of bars; a plurality of bus pins, wherein the plurality of bus pins are connected to the plurality of bars; a neutral bus; and an overmold, wherein the overmold supports the plurality of bars, the plurality of bus pins, and the neutral bus, wherein the overmold defines: a plurality of hairpin housings, wherein the plurality of hairpin housings define a plurality of blind-holes; and a temperature sensor housing, wherein the temperature sensor housing defines an additional blind-hole.

In some aspects, the overmold defines a surface, wherein the plurality of hairpin housings and the temperature sensor housing extend from the surface.

In some aspects, the plurality of blind-holes and the additional blind-hole are oriented in parallel, wherein the plurality of blind-holes and the additional blind-hole are orthogonal to the surface.

In some aspects, the additional blind-hole is up to the surface.

In some aspects, the temperature sensor housing includes a base portion and a tip portion, wherein the base portion extends from the surface, wherein the tip portion extends from the base portion, wherein the additional blind-hole is defined through the base portion and the tip portion up to the surface.

In some aspects, the temperature sensor housing includes an L-shaped cross-section disposed orthogonal to the surface, wherein the base portion defines a base of the L-shaped cross-section, wherein the tip portion defines a tip of the L-shaped cross-section.

In some aspects, the base portion includes a rectangular-shaped cross-section which is parallel to the surface, wherein the tip portion includes a U-shaped cross-section parallel to the surface.

In some aspects, the rectangular-shaped cross-section is a rounded-rectangle.

In some aspects, the temperature sensor housing is taller than the plurality of hairpin housings.

In some aspects, the base portion is taller than the plurality of hairpin housings.

In some aspects, the additional blind-hole is longer than the plurality of blind-holes.

In some aspects, the tip portion defines a first length of the additional blind-hole, wherein a remaining length of the additional blind-hole not defined by the first length is a same length as the plurality of blind-holes.

In some aspects, the plurality of blind-holes and the additional blind-hole are a same width.

In some aspects, the additional blind-hole includes a draft angle of at least one-degree.

In some aspects, the surface includes an arcuate shape defining an inner-radius and an outer-radius of the busbar, wherein the tip portion is a radially outermost portion of the temperature sensor housing.

In some aspects, the busbar is a three-phase busbar, wherein the plurality of bars include a first-phase bar, a second-phase bar, and a third-phase bar, wherein the plurality of bus pins include a plurality of first-phase bus pins, a plurality of second-phase bus pins, and a plurality of third-phase bus pins, wherein the plurality of first-phase bus pins are connected to the first-phase bar, wherein the plurality of second-phase bus pins are connected to the second-phase bar, wherein the plurality of third-phase bus pins are connected to the third-phase bar.

In some aspects, a first set of the plurality of first-phase bus pins, the plurality of second-phase bus pins, and the plurality of third-phase bus pins are disposed along the inner-radius, wherein a second set of plurality of first-phase bus pins, the plurality of second-phase bus pins, and the plurality of third-phase bus pins are disposed along the outer-radius.

A stator is described, in accordance with one or more embodiments of the present disclosure. The stator may include: a busbar including: a plurality of bars; a plurality of bus pins, wherein the plurality of bus pins are connected to the plurality of bars; a neutral bus; and an overmold, wherein the overmold supports the plurality of bars, the plurality of bus pins, and the neutral bus, wherein the overmold defines: a plurality of hairpin housings, wherein the plurality of hairpin housings define a plurality of blind-holes; and a temperature sensor housing, wherein the temperature sensor housing defines an additional blind-hole; a stator core; a winding, wherein the winding is electrically connected to the plurality of bus pins and the neutral bus, the winding including a plurality of hairpins, wherein the plurality of hairpins couple to the plurality of hairpin housings and the temperature sensor housing; and a temperature sensor, wherein the temperature sensor and a pair of the plurality of hairpins are housed within the additional blind-hole, wherein the temperature sensor abuts one of the pair of the plurality of hairpins.

In some aspects, the overmold defines a surface, wherein the plurality of hairpin housings and the temperature sensor housing extend from the surface, wherein the plurality of blind-holes and the additional blind-hole are oriented in parallel, wherein the plurality of blind-holes and the additional blind-hole are orthogonal to the surface, wherein the temperature sensor housing includes a base portion and a tip portion, wherein the base portion extends from the surface, wherein the tip portion extends from the base portion, wherein the additional blind-hole is defined through the base portion and the tip portion up to the surface, wherein the temperature sensor is disposed within a portion of the additional blind-hole defined by the tip portion.

An electric motor is described, in accordance with one or more embodiments of the present disclosure. The electric motor may include: a stator including: a busbar including: a plurality of bars; a plurality of bus pins, wherein the plurality of bus pins are connected to the plurality of bars; a neutral bus; and an overmold, wherein the overmold supports the plurality of bars, the plurality of bus pins, and the neutral bus, wherein the overmold defines: a plurality of hairpin housings, wherein the plurality of hairpin housings define a plurality of blind-holes; and a temperature sensor housing, wherein the temperature sensor housing defines an additional blind-hole; a stator core; a winding, wherein the winding is electrically connected to the plurality of bus pins and the neutral bus, the winding including a plurality of hairpins, wherein the plurality of hairpins couple to the plurality of hairpin housings and the temperature sensor housing; and a temperature sensor, wherein the temperature sensor and a pair of the plurality of hairpins are housed within the additional blind-hole, wherein the temperature sensor abuts one of the pair of the plurality of hairpins; a junction box coupled to the plurality of bars; and a rotor disposed within a central axis of the stator.

### BRIEF DESCRIPTION OF THE DRAWINGS

The numerous advantages of the disclosure may be better understood by those skilled in the art by reference to the accompanying figures in which:

FIG. 1A depicts a top-front perspective view of a busbar, in accordance with one or more embodiments of the present disclosure.

FIG. 1B depict a top-rear perspective view of the busbar, in accordance with one or more embodiments of the present disclosure.

FIG. 1C depicts a bottom-front perspective view of the busbar, in accordance with one or more embodiments of the present disclosure.

FIG. 1D depicts a partial view of FIG. 1C, in accordance with one or more embodiments of the present disclosure.

FIG. 1E depicts a front view of the busbar, in accordance with one or more embodiments of the present disclosure.

FIG. 1F depicts a partial view of FIG. 1E, in accordance with one or more embodiments of the present disclosure.

FIG. 2A depicts a front perspective view of a stator with the busbar, in accordance with one or more embodiments of the present disclosure.

FIG. 2B depicts a partial-rear perspective view of the stator with the busbar, in accordance with one or more embodiments of the present disclosure.

FIG. 2C depicts a partial-front perspective view of the stator with the busbar, in accordance with one or more embodiments of the present disclosure.

FIG. 3 depicts an electric motor with the stator, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to busbar. The busbar may include bars, bus pins connected to the bars, a neutral bus, and an overmold. The overmold may support the bars, the bus pins, and the neutral bus. The overmold may also define hairpin housings and a temperature sensor housing. A stator may include the busbar, a temperature sensor, and a winding. The winding may be made of hairpins. The hairpin housing may house pairs of the hairpins. The temperature sensor housing may house the temperature sensor and a pair of the hairpins. The temperature sensor may abut one of the pair of the hairpins within the temperature sensor housing such that the temperature sensor may measure the temperature of the hairpins. An electric motor may include the stator and a rotor.

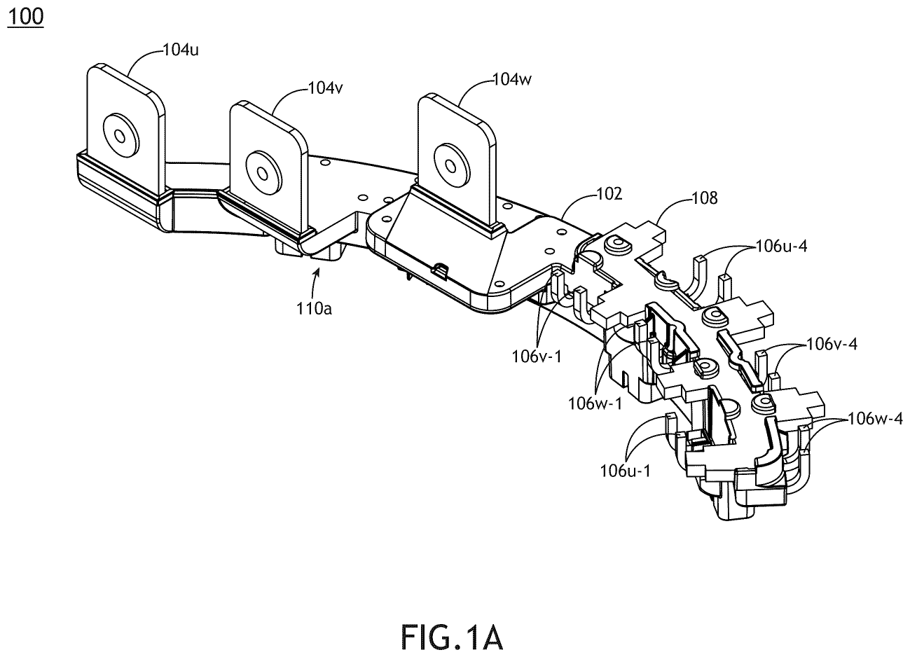

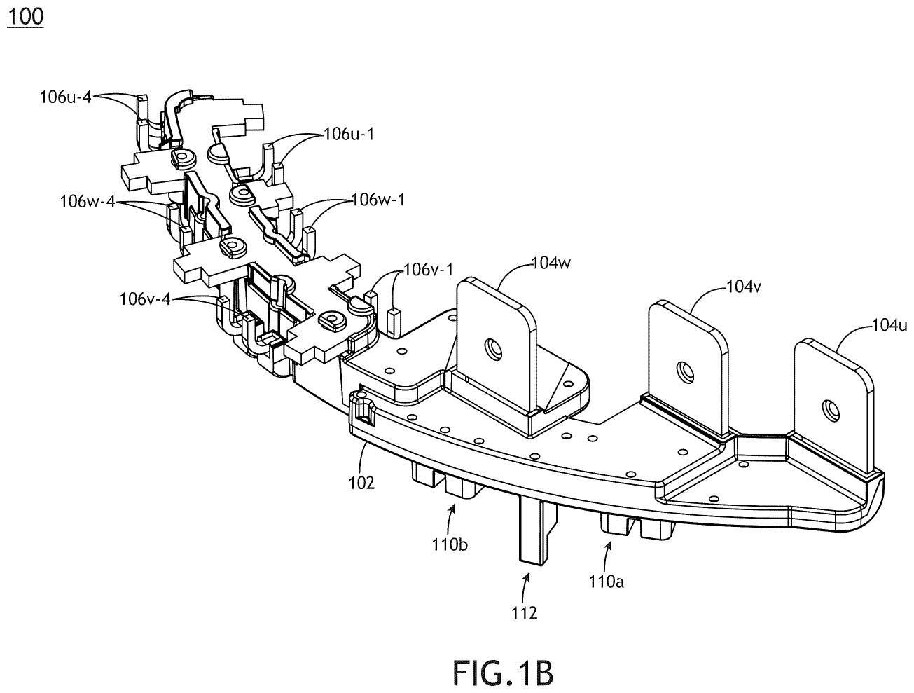

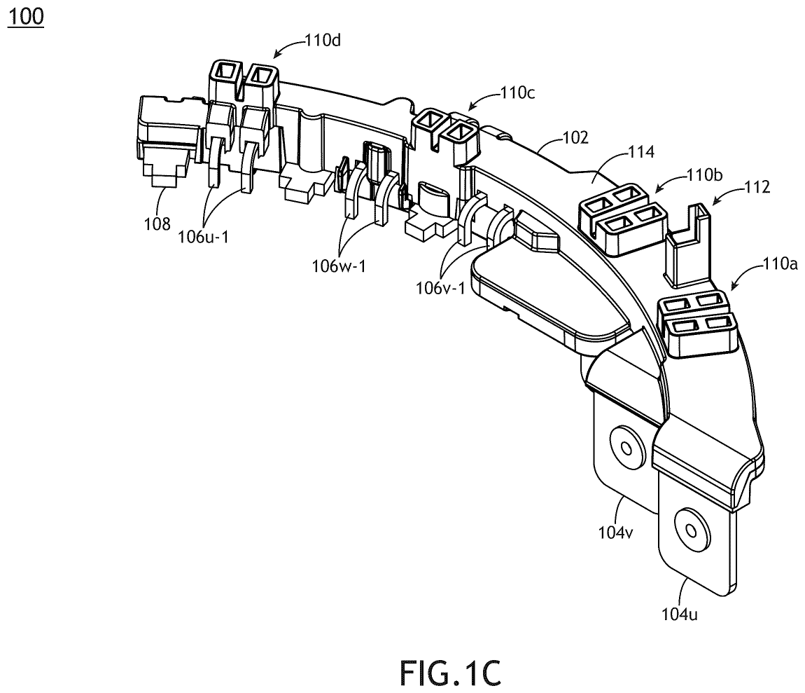

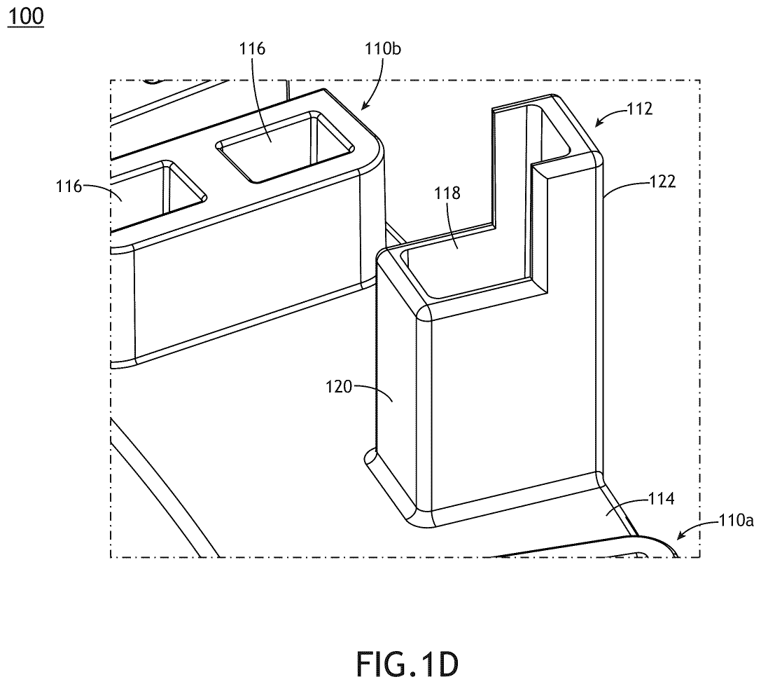

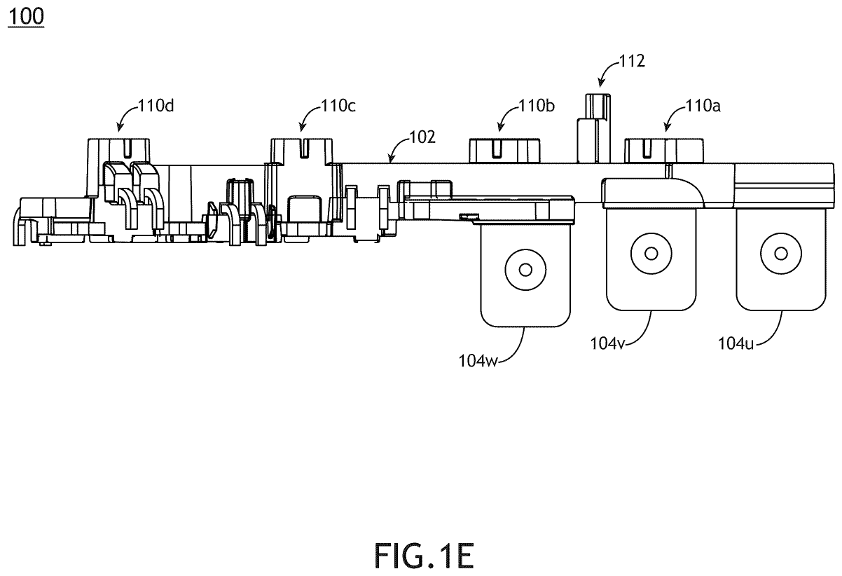

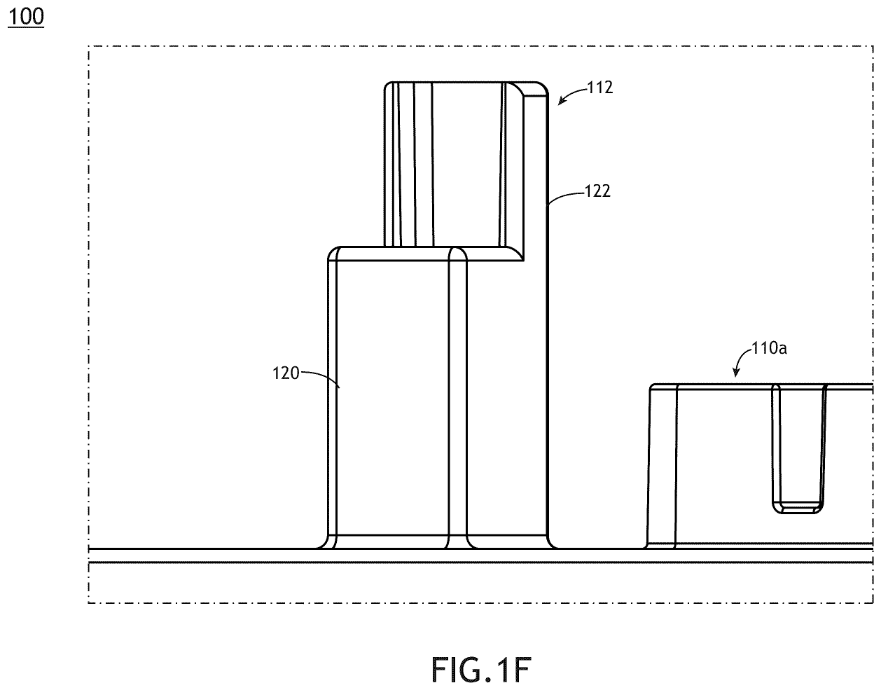

FIGS. 1A-1F depict a busbar 100, in accordance with one or more embodiments of the present disclosure. The busbar 100 may be a connection bar for a stator of an electric motor. The busbar 100 may include one or more components, such as, but not limited to, an overmold 102, bars 104, bus pins 106, and/or a neutral bus 108.

The busbar 100 may receive and distribute three current. For example, the bus pins 106 may receive the current by the bars 104 and distribute the current from the bus pins 106. The bars 104, the bus pins 106, the neutral bus 108 and/or the hairpins 208 may be made from any electrically conductive material. The electrically conductive material may be a rigid metallic element formed from metal. For example, the bars 104, the bus pins 106, the neutral bus 108 may be made from copper, a copper alloy, or the like.

The overmold 102 may support the bars 104, the bus pins 106, and the neutral bus 108. For example, the bars 104, the bus pins 106, and the neutral bus 108 may be coupled to the overmold 102. The overmold 102 may bear the weight from the bars 104, the bus pins 106, and the neutral bus 108.

The overmold 102 may be an electrical insulator. The overmold 102 may be any material which is an electrical insulator to insulate the bars 104, the bus pins 106, and the neutral bus 108. The overmold 102 may be made of a plastic material or the like. The plastic material may include one or more material properties, such as, but not limited to, high electrical resistance, high rigidity, high shock resistance, high resilience, high resistance to thermal deformation, very high dimensional stability, good sliding properties, good fatigue resistance, easy to machine, and/or good resistance to chemicals such as organic solvents and fuels.

The plastic material may include, but is not limited to, polyamide (PA66), Polyphthalamide (PPA), or the like. For example, the polyamide may be PA6, PA66, or the like. The plastic material may be a fiber-reinforced matrix which is impregnated with one or more fibers. The fibers may include glass, fiberglass, carbon fiber, aramid, carbon fibers, or the like. The fibers may include a load percentage. The load percentage of the fibers may be between 30% and 40%. For example, the plastic material may be polyamide 66 with 30% glass fiber (i.e., PA66-GF30). By way of another example, the plastic material may be Polyphthalamide with 40% glass fiber (i.e., PPA-GF40).

The overmold 102 may be plastic injection molded. For example, the overmold 102 may be plastic injection molded over portions of the bars 104, the bus pins 106, and/or the neutral bus 108.

The overmold 102 may define hairpin housings 110, a temperature sensor housing 112, and/or a surface 114.

The surface 114 may be a planar surface. The surface 114 may be flat along a horizontal plane. The surface 114 may not include any significant curvature along the horizontal plane. The surface 114 may be thinner than wide or long. Although the surface 114 is described as a planar surface, this is not intended as a limitation of the present disclosure. It is further contemplated that the surface 114 may be a non-planar surface.

The surface 114 may be disposed between the neutral bus 108 and the hairpin housings 110 and/or the temperature sensor housing 112. The hairpin housings 110 and/or the temperature sensor housing 112 may extend from the surface 114. The hairpin housings 110 and/or the temperature sensor housing 112 may be configured to support the busbar 100. For example, the hairpin housings 110 and/or the temperature sensor housing 112 may be configured to support the bars 104, the bus pins 106, and the neutral bus 108 through the surface 114.

The surface 114 may include an arcuate shape. The surface 114 may include the arcuate shape in the horizontal plane. The arcuate shape may be curved along an arc with a radius. The arcuate shape may define the inner-radius and the outer-radius of the busbar 100. The hairpin housings 110 and/or the temperature sensor housing 112 may be aligned along the radius of the arcuate shape.

The hairpin housings 110 and the temperature sensor housing 112 may define blind-holes 116 and a blind-hole 118, respectively. The blind-holes 116 may be referred to as a plurality of blind-holes. The blind-hole 118 may be referred to as an additional blind-hole.

The blind-holes 116 and/or the blind-hole 118 may be oriented in parallel. The blind-holes 116 and/or the blind-hole 118 may be defined up to the surface 114. The blind-holes 116 and/or the blind-hole 118 may be orthogonal to the surface 114. For example, the blind-holes 116 and/or the blind-hole 118 may project downwards directly from the surface 114.

The blind-holes 116 and/or the blind-hole 118 may include a selected cross-section. For example, the blind-holes 116 and/or the blind-hole 118 may include a rounded-rectangle shaped cross-section. The rounded-rectangle shaped cross-section may include four fillet corners.

The blind-holes 116 and/or the blind-hole 118 may include a draft angle. The draft angle may also be referred to as a taper. The draft angle of the blind-holes 116 and the blind-hole 118 may be an angle of the inner walls of the hairpin housings 110 and the temperature sensor housing 112, respectively, relative to the surface 114. The draft angle may include, but is not limited to, at least one-degree. The draft angle may assist with molding the hairpin housings 110 and/or the temperature sensor housing 112. For example, the draft angle may allow releasing the hairpin housings 110 and/or the temperature sensor housing 112 from an injection mold.

The temperature sensor housing 112 may include a base portion 120 and a tip portion 122.

The base portion 120 and the tip portion 122 may jointly define the blind-hole 118. The blind-hole 118 may be defined through the tip portion 122 and the base portion 120 up to the surface 114.

The temperature sensor housing 112 may include an L-shaped cross-section. The L-shaped cross-section may be orthogonal to the surface 114. The base portion 120 and the tip portion 122 may define the base and the tip of the L-shaped cross-section, respectively.

The base portion 120 may extend from the surface 114. The tip portion 122 may extend from the base portion 120. The base portion 120 may be disposed between the surface 114 and the tip portion 122.

The base portion 120 may be a rectangular tube. For example, the base portion 120 may include a rectangular-shaped cross-section with a hollow center defining the blind-hole 118. The rectangular-shaped cross-section may be parallel to the surface 114. The base portion 120 may include four outer corners. The outer corners may include a radius, such that the outer corners are fillet corners. The base portion 120 may include four inner corners. The four inner corners may define the corners of the blind-hole 118. For example, the corners of the blind-hole 118 with the rectangular-shaped cross-section may be fillet corners such that the rectangular-shaped cross-section is a rounded-rectangle.

The tip portion 122 may be a partial rectangular tube. For example, the tip portion 122 may include a U-shaped cross-section. The U-shaped cross-section may be parallel to the surface 114. The tip portion 122 may include two outer corners. The outer corners may include a radius, such that the outer corners are fillet corners. The tip portion 122 may include two inner corners. The two inner corners may define two of the corners of the blind-hole 118.

The tip portion 122 may be aligned with a portion of the base portion 120. The two outer corners and the two inner corners of the tip portion 122 may be aligned with two of the four outer corners and two of the four inner corners, respectively, of the base portion 120. The remaining third and fourth of each of the four outer corners and the four inner corners of the base portion 120 may be uncovered by the tip portion 122.

The temperature sensor housing 112 may be taller than the hairpin housings 110. The height of the temperature sensor housing 112 may be taller than the height of the hairpin housings 110. The height may refer to a distance from the surface 114. Similarly, the height of the blind-hole 118 may be taller than the height of the blind-holes 116. The base portion 120 of the temperature sensor housing 112 may also be taller than the hairpin housings 110. The height of the base portion 120 of the temperature sensor housing 112 may be taller than the height of the hairpin housings 110.

The blind-hole 118 may be longer than the blind-holes 116. The blind-hole 118 may include a length which is longer than a length of the blind-holes 116. The length may refer to a radial position relative a center of the arcuate portion of the surface 114. The tip portion 122 may define a first length of the blind-hole 118. A remaining length of the blind-hole 118 which is not defined by the tip portion 122 may be a same length as the blind-holes 116.

The blind-holes 116 may be a same width as the blind-hole 118. The blind-holes 116 and the blind-hole 118 may be the same width. The width may refer to the distance along the arcuate shape of the surface 114. For example, the blind-holes 116 may be a same width as the blind-hole 118 at a given height from the surface 114. The widths of the blind-holes 116 and the blind-hole 118 may each change at a same rate from the surface 114 according to the draft angle.

The overmold 102 may include any configuration of the hairpin housings 110. In the example configuration, the overmold 102 defines four of the hairpin housings 110, although this is not intended to be limiting. It is contemplated that the overmold 102 may define any integer number of the hairpin housings 110. The overmold 102 may include any number of the hairpin housings 110. The overmold 102 may include one set, two sets, three sets, four sets, or more of the hairpin housings 110. For example, the overmold 102 may include a first hairpin housing 110a, a second hairpin housing 110b, a third hairpin housing 110c, and a fourth hairpin housing 110d, although this is not intended to be limiting.

The temperature sensor housing 112 may be disposed between adjacent of the hairpin housings 110. For example, the temperature sensor housing 112 may be disposed between the first hairpin housing 110a and the second hairpin housing 110b.

The hairpin housings 110 may include any configuration of the blind-holes 116. For example, the first hairpin housing 110a and the second hairpin housing 110b may include a two-by-two configuration of the blind-holes 116. By way of another example, the third hairpin housing 110c and the fourth hairpin housing 110d may include a one-by-two configuration of the blind-holes 116.

The temperature sensor housing 112 may be disposed along an outer-radius of the busbar 100. The tip portion 122 may be a radially outermost portion of the temperature sensor housing 112. A remainder of the blind-hole 118 defined the base portion 120 may be disposed radially inwards of the tip portion 122.

The blind-hole 118 may be radially aligned with one or more of the blind-holes 116 along the outer-radius of the busbar 100. For example, the first pair of the blind-holes 116 and the blind-hole 118 may be radially aligned along the outer-radius of the busbar 100.

One or more of the blind-holes 116 may be radially aligned. The hairpin housings 110 may define pairs of the blind-holes 116 which may be radially aligned along a common radius. For example, each of the hairpin housings 110 may include pairs of the blind-holes 116 which may be radially aligned along a common radius.

One or more of the blind-holes 116 may be disposed radially outwards from adjacent of the blind-holes 116. For example, a first pair of the blind-holes 116 of the first hairpin housing 110a and the second hairpin housing 110b may be disposed radially outwards from a second pair of the blind-holes 116, where the first pair of the blind-holes 116 of the third and fourth of the hairpin housings 110 are radially aligned and where the second pair of the blind-holes 116 of the third and fourth of the hairpin housings 110 are radially aligned. The first pair of the blind-holes 116 of the first hairpin housing 110a and the second hairpin housing 110b may be disposed along an outer-radius. The second pair of the blind-holes 116 may be disposed along an inner-radius.

The busbar 100 may be a three-phase busbar. The busbar 100 may receive and distribute three phases of current. For example, the bus pins 106 may receive the three phases of current by the bars 104 and distribute the three phases of current from the bus pins 106. The three phases may include a first-phase (u), a second-phase (v), and a third-phase (w). The first-phase (u), the second-phase (v), and the third-phase (w) may be aligned 120-degrees out of phase.

The bars 104 may be rigid elements. Each of the bars 104 may be associated with a respective phase of electricity. The busbar 100 may include any number of the bars 104. The bars 104 may include a first-phase bar 104u, a second-phase bar 104v, and a third-phase bar 104w. The first-phase bar 104u may be associated a first-phase (u) of electricity, the second-phase bar 104v may be associated with a second-phase (v) of electricity, and the third-phase bar 104w may be associated with a third-phase (w) of electricity, respectively.

The busbar 100 may include the first-phase bar 104u, the second-phase bar 104v, and the third-phase bar 104w arranged in a sequence. For example, the second-phase bar 104v may be disposed between the first-phase bar 104u and the third-phase bar 104w.

The hairpin housings 110 and/or the temperature sensor housing 112 may be disposed at any position below the bars 104. For example, the temperature sensor housing 112 may be disposed below and aligned between the second-phase bar 104v and the third-phase bar 104w. One or more of the hairpin housings 110 may be disposed below and aligned with the bars 104. For example, the first hairpin housing 110a and/or the second hairpin housing 110b may be disposed below and aligned with the second-phase bar 104v and the third-phase bar 104w, respectively.

The bus pins 106 may be rigid elements. The bus pins 106 may be connected to the bars 104. Each of the bus pins 106 may be associated with a respective phase of electricity. For example, the bus pins 106 may include first-phase bus pins 106u, second-phase bus pins 106v, and third-phase bus pins 106w. The first-phase bus pins 106u may be connected to the first-phase bar 104u, the second-phase bus pins 106v may be connected to the second-phase bar 104v, and the third-phase bus pins 106w may be connected to the third-phase bar 104w, respectively. The bus pins 106 may be connected to the bars 104 via one or more internal traces (not depicted) within the busbar 100 for distributing current from the bars 104 to the bus pins 106.

The busbar 100 may include sets of the bus pins 106 disposed along an inner-radius and/or an outer-radius of the busbar 100. A first set of the first-phase bus pins 106u, the second-phase bus pins 106v, and the third-phase bus pins 106w may be disposed along an inner-radius of the busbar 100. A second set of the first-phase bus pins 106u, the second-phase bus pins 106v, and the third-phase bus pins 106w may be disposed along an outer-radius of the busbar 100. For example, the first-phase bus pins 106u may include inner-radius, first-phase bus pins 106u-1 disposed along the inner-radius and/or may include outer-radius, first-phase bus pins 106u-4 disposed along the outer-radius. By way of another example, the second-phase bus pins 106v may include inner-radius, second-phase bus pins 106v-1 disposed along the inner-radius and/or may include outer-radius, second-phase bus pins 106v-4 disposed along the outer-radius. By way of another example, the third-phase bus pins 106w may include inner-radius, third-phase bus pins 106w-1 disposed along the inner-radius and/or may include outer-radius, third-phase bus pins 106w-4 disposed along the outer-radius.

The neutral bus 108 may be a common neutral between each of the phases. The neutral bus 108 may or may not be connected to ground.

The hairpin housings 110 may be disposed at any position below the neutral bus 108. One or more of the hairpin housings 110 may be disposed below and aligned with the neutral bus 108. For example, the third hairpin housing 110c and/or the fourth hairpin housing 110d may be disposed below and aligned with the neutral bus 108.

The bus pins 106 and the neutral bus 108 may alternate in sequence. For example, the sequence may include the first-phase bus pins 106u, the neutral bus 108, the second-phase bus pins 106v, the neutral bus 108, the third-phase bus pins 106w, and the neutral bus 108 alternating in sequence. The first-phase bus pins 106u, the second-phase bus pins 106v, and the third-phase bus pins 106w may be arranged along the outer-radius and along the inner-radius in a select pattern with the neutral bus 108. For example, the inner-radius may include the neutral bus 108, followed by the inner-radius, third-phase bus pins 106w-1, followed by the neutral bus 108, followed by the inner-radius, first-phase bus pins 106u-1, followed by the neutral bus 108, followed by the inner-radius, first-phase bus pins 106v-1. By way of another example, the outer-radius may include the outer-radius, first-phase bus pins 106u-4, followed by the neutral bus 108, followed by the outer-radius, second-phase bus pins 106v-4, followed by the neutral bus 108, followed by the outer-radius, third-phase bus pins 106w-1, followed by the neutral bus 108.

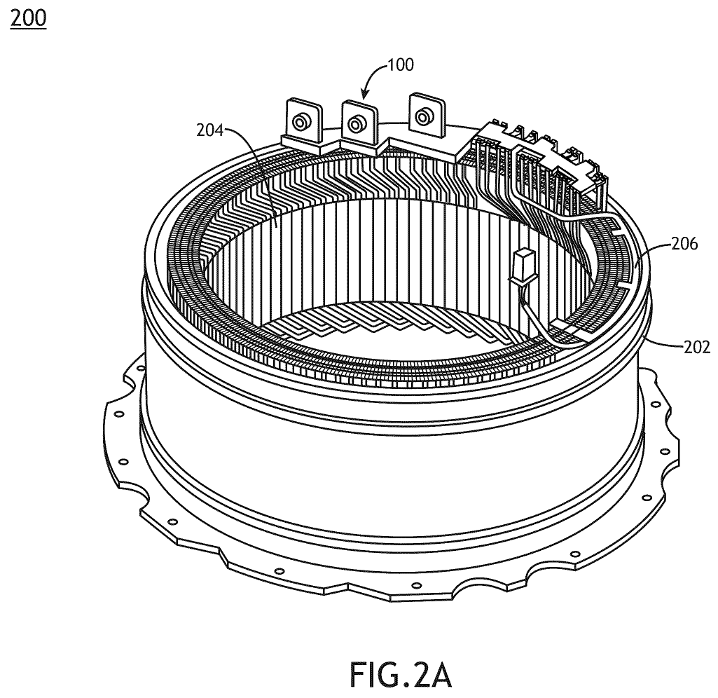

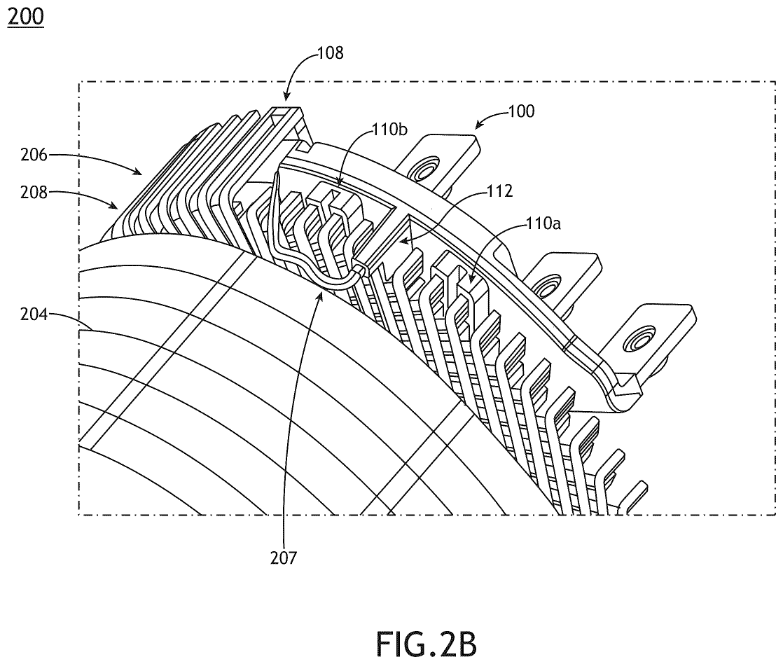

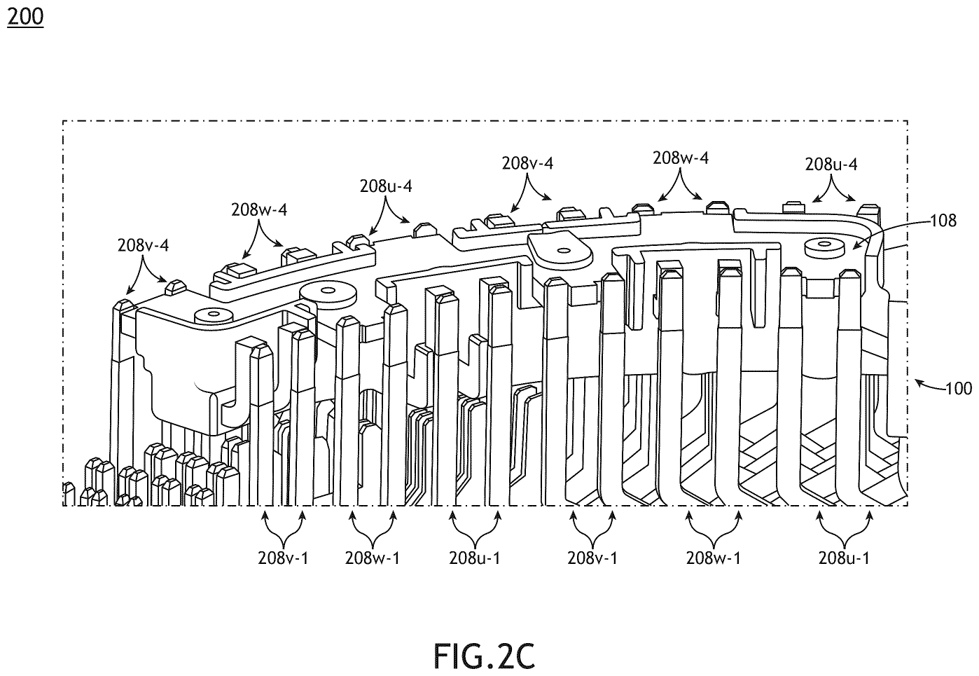

FIGS. 2A-2C depict a stator 200, in accordance with one or more embodiments of the present disclosure. The stator 200 may include the busbar 100, a stator carrier 202, a stator core 204, a winding 206, and/or a temperature sensor 207.

The winding 206 may include any suitable type of winding, such as, but not limited to, a hairpin winding (e.g., a hairpin lap winding) or the like. The winding 206 may include a plurality of the hairpins 208. The hairpins 208 may be joined together to form the winding 206. For example, the hairpins 208 may be joined together by a weld (e.g., a laser weld) to form the winding 206. The hairpins 208 may be flat bars which may be bent into a select shape. For example, the hairpins 208 may include a “U-shape” or the like.

The winding 206 may support the busbar 100. The busbar 100 may be disposed on and coupled to the winding 206. The hairpins 208 of the winding 206 may couple to the hairpin housings 110 and/or the temperature sensor housing 112. The hairpins 208 of the winding 206 may couple to the hairpin housings 110 and/or the temperature sensor housing 112 via the blind-holes 116 and the blind-hole 118, respectively. The winding 206 may support the busbar 100 via the hairpin housings 110 and/or the temperature sensor housing 112. The addition of more of the hairpin housings 110 may provide more support when coupling to the hairpins 208 of the winding 206, at the expense of additional weight and material for the busbar 100. Similarly, the addition of more of the blind-holes 116 per each of the hairpin housings 110 may provide more support when coupling to the hairpins 208 of the winding 206, at the expense of additional weight and material for the busbar 100.

The hairpin housings 110 may house the hairpins 208. Each of the blind-holes 116 of the hairpin housings 110 may house a pair of the hairpins 208. The pair of the hairpins 208 may be press fit into the hairpin housings 110, thereby coupling the winding 206 to the hairpin housings 110. The draft angle of the blind-holes 116 may be beneficial for press fitting the hairpins 208 into the blind-holes 116.

The hairpin housings 110 may couple to the hairpins 208 in any suitable configuration. For example, the first hairpin housing 110a and the second hairpin housing 110b may each house eight pairs of the hairpins 208 within four of the blind-holes 116 in the two-by-two configuration. Thus, each of the first hairpin housing 110a and the second hairpin housing 110b may house a total of sixteen of the hairpins 208. The third hairpin housing 110c and the fourth hairpin housing 110d may each house two pairs of the hairpins 208 within two of the blind-holes 116 in the one-by-two configuration. Thus, each of the third hairpin housing 110c and the fourth hairpin housing 110d may house a total of eight of the hairpins 208. In this example, the hairpin housings may house a total of forty-eight of the hairpins 208, although this is not intended to be limiting.

The temperature sensor housing 112 may house the temperature sensor 207 and a pair of the hairpins 208. The blind-hole 118 of the temperature sensor housing 112 may house the temperature sensor 207 and the pair of the hairpins 208. The temperature sensor 207 may be disposed within the portion of the blind-hole 118 defined by the tip portion 122 of the temperature sensor housing 112. The pair of the hairpins 208 may be disposed within the remainder of the blind-hole 118 defined by the base portion 120. The blind-hole 118 of the temperature sensor housing 112 may be longer than the blind-holes 116 of the hairpin housings 110 to enable the blind-hole 118 to house the temperature sensor 207 in addition to the pair of the hairpins 208. The blind-holes 116 and the remaining length of the blind-hole 118 which is not defined by the tip portion 122 may each be configured to receive the pair of the hairpins 208. The tip portion 122 may cause the length of the blind-hole 118 to be longer than the length of the blind-holes 116 for receiving the temperature sensor 207 in combination with the pair of the hairpins 208.

The temperature sensor housing 112 and the pair of the hairpins 208 may be press fit into the temperature sensor housing 112, thereby coupling the winding 206 to the temperature sensor housing 112. The draft angle of the blind-hole 118 may be beneficial for press fitting the temperature sensor 207 and the hairpins 208 into the blind-hole 118.

The temperature sensor 207 may abut the winding 206. The temperature sensor 207 may abut the winding 206 within the temperature sensor housing 112. A portion of the temperature sensor 207 may also abut the winding 206 below the temperature sensor housing 112. The temperature sensor 207 may abut one of the pair of the hairpins 208. The temperature sensor 207 may measure the temperature of the hairpin 208 to which the temperature sensor 207 is abutted. The temperature sensor housing 112 may allow the temperature sensor 207 to be attached to the winding 206 at the hottest point. The benefits of this implementation may include a reduction of components of the stator 200, which may reduce manufacturing and assembly time.

The winding 206 may include a radius. The radius of the arcuate shape defined by the surface 114 may align with the radius of the winding 206. The temperature sensor 207 may be disposed radially outwards of the pair of the hairpins 208 within the temperature sensor housing 112.

The winding 206 may be electrically connected to the busbar 100. For example, the winding 206 may be electrically connected to the bus pins 106 and the neutral bus 108. The hairpins 208 may connect the winding 206 to the bus pins 106 and/or the neutral bus 108. The hairpins 208 which are connected to the bus pins 106 and the neutral bus 108 may be referred to as voltage terminals or neutral terminals, respectively. The hairpins 208 may be connected to the bus pins 106 and/or to the neutral bus 108 by one or more welds. The winding 206 may receive the current from the busbar 100 and induce a magnetic field.

The winding 206 may be a three-phase winding including the first-phase (u), the second-phase (v), and the third-phase (w). The winding 206 may include poles which alternate in sequence between the first-phase (u), the second-phase (v), and the third-phase (w). The hairpins 208 may carry a respective of the phases to define the poles. For example, the hairpins 208 may include first-phase hairpins 208u, second-phase hairpins 208v, and third-phase hairpins 208w. The first-phase hairpins 208u, second-phase hairpins 208v, and third-phase hairpins 208w may similarly be arranged in the alternating arrangement.

The first-phase hairpins 208u, second-phase hairpins 208v, and third-phase hairpins 208w may be connected to the first-phase bus pins 106u, the second-phase bus pins 106v, and the third-phase bus pins 106w, respectively. The connection between the hairpins 208 and the bus pins 106 may be referred to as a pin/pin connection. The busbar 100 may distribute current for the winding 206. For example, the busbar 100 may distribute each of the phases of current to the winding 206. The busbar 100 may distribute the three phases to the hairpins 208 through the bus pins 106.

The first-phase hairpins 208u, second-phase hairpins 208v, and third-phase hairpins 208w of the winding 206 may each be connected to the neutral bus 108. The hairpins 208 may couple the winding 206 to the neutral bus 108 of the busbar 100. The connection between the hairpins 208 and the neutral bus 108 may be referred to as a pin/neutral connection.

The winding 206 may connect to both the bus pins 106 and the neutral bus 108 of the busbar 100. The winding 206 may be a “wye” transformer by being connected at a first end to the first-phase bus pins 106u, the second-phase bus pins 106v, and the third-phase bus pins 106w, respectively, and by being connected at a second end to the neutral bus 108.

The winding 206 may also include a select number of layers. The winding 206 may include a two-layer winding, a four-layer winding, and the like. For example, the winding 206 may be the four-layer winding. The four-layer winding may include a first-layer disposed closest to the inner-radius of the stator core 204, a second-layer disposed adjacent to the first-layer, and a third-layer disposed adjacent to the second-layer, and a fourth-layer disposed closest to the outer-radius of the stator core 204. The winding 206 may include a first set of the hairpins 208 which may span between the first and second of the layers. The winding 206 may also include a second set of the hairpins 208 which may span between the third and fourth of the layers. The first set of the hairpins 208 and the second set of the hairpins 208 may each include the first-phase hairpins 208u, the second-phase hairpins 208v, and the third-phase hairpins 208w.

Each of the blind-holes 116 of the hairpin housings 110 may house a pair of the hairpins 208 across two layers of the winding 206. For example, the blind-holes 116 of the first hairpin housing 110a and/or the second hairpin housing 110b may house pairs of the hairpins 208 across the first layer and the second layer of the winding 206 and may also house pairs of the hairpins 208 across the third layer and the fourth layer of the winding 206. By way of another example, the blind-holes 116 of the third hairpin housing 110c and/or the fourth hairpin housing 110d may house pairs of the hairpins 208 across the third layer and the fourth layer of the winding 206.

The temperature sensor housing 112 may house the temperature sensor 207 with the pair of the hairpins 208 across two layers of the winding 206. For example, the temperature sensor housing 112 may house the pair of the hairpins 208 in the third layer and the fourth layer in combination with housing the temperature sensor 207, where the temperature sensor 207 is disposed radially outwards of the pair of the hairpins 208.

The hairpins 208 may be disposed in one or more layers of the winding 206. The hairpins 208 may be disposed in the first-layer, the second-layer, the third-layer, and/or the fourth-layer of the winding 206, where the winding 206 is a four-layer winding. For example, the first-phase hairpins 208u may include first-layer, first-phase hairpins 208u-1 disposed in the first-layer and/or may include fourth-layer, first-phase hairpins 208u-4 disposed in the fourth-layer. By way of another example, the second-phase hairpins 208v may include first-layer, second-phase hairpins 208v-1 disposed in the first-layer and/or may include fourth-layer, second-phase hairpins 208v-4 disposed in the fourth-layer. By way of another example, the third-phase hairpins 208w may include first-layer, third-phase hairpins 208w-1 disposed in the first-layer and/or may include fourth-layer, third-phase hairpins 208w-4 disposed in the fourth-layer.

The first-phase bus pins 106u, the second-phase bus pins 106v, and the third-phase bus pins 106w disposed along the inner-radius and the outer-radius may connect to the hairpins 208 disposed in the first-layer and the fourth-layer, respectively. For example, the first-layer, first-phase hairpins 208u-1 and the fourth-layer, first-phase hairpins 208u-4 may be connected to the inner-radius, first-phase bus pins 106u-1 and the outer-radius, first-phase bus pins 106u-4, respectively. By way of another example, the first-layer, second-phase hairpins 208v-1 and the fourth-layer, second-phase hairpins 208v-4 may be connected to the inner-radius, second-phase bus pins 106v-1 and the outer-radius, second-phase bus pins 106v-4, respectively. By way of another example, the first-layer, third-phase hairpins 208w-1 and the fourth-layer, third-phase hairpins 208w-4 may be connected to the inner-radius, third-phase bus pins 106w-1 and the outer-radius, third-phase bus pins 106w-4, respectively.

The winding 206 may define one or more poles. The poles defined by the winding 206 may be arranged in sectors around a central axis of the winding 206. For example, the winding 206 may define twelve-poles which may be arranged in thirty-degree sectors around the central axis, although this is not intended to be limiting. The winding 206 may also include greater than or less than the twelve-poles.

The hairpins 208 may include varying sizes. The varying sizes of the hairpins 208 may be based on the layers to which the hairpins 208 may be disposed. The first set of the hairpins 208 may be smaller than the second set of the hairpins 208 to maintain the alignment of the first-phase hairpins 208u, the second-phase hairpins 208v, and the third-phase hairpins 208w, respectively, in the poles across the layers.

The winding 206 may include one or more hairpins-per-pole-group. The hairpins-per-pole-group may be the number of the hairpins 208 at a select phase which are grouped to define each of the poles. The winding 206 may include one, two, three, or more of the hairpins-per-pole-group. For example, the winding 206 may include two of the hairpins-per-pole-group at a respective phase, although this is not intended as a limitation of the present disclosure. For instance, the winding 206 may include two of the first-phase hairpins 208u, two of the second-phase hairpins 208v, and two of the third-phase hairpins 208w per-pole-group.

The pole-groups of the hairpins 208 may be aligned across the layers of the winding 206, where the winding 206. For example, the first-phase hairpins 208u may be aligned, the second-phase hairpins 208v may be aligned, and the third-phase hairpins 208w may be aligned across the layers to cooperatively define the poles.

The hairpin housings 110 may house multiple of the hairpins 208 by the blind-holes 116 which are radially aligned regardless of whether the hairpins 208 are in a same pole-group. The hairpin housings 110 may house multiple of the hairpins 208 regardless of whether the hairpins 208 are in a same pole-group because the hairpin housings 110 do not electrically connect to the hairpins 208. The first hairpin housing 110a and the second hairpin housing 110b may or may not house the hairpins 208 with a same pole-group. For example, the second hairpin housing 110b may house the hairpins 208 with a same pole-group and the first hairpin housing 110a may house the hairpins 208 across adjacent of the pole-groups, although this is not intended to be limiting.

The stator carrier 202 may be a housing for the components of the stator 200. The stator carrier 202 may encapsulate the stator core 204, the winding 206, and the like. The stator core 204 and/or the winding 206 may be disposed within the stator carrier 202.

The stator core 204 may be made of stacks of one or more stacks of lamination. The stator core 204 may define one or more slots for the winding 206. The winding 206 of the stator 200 may disposed in the slots of the stator core 204. The busbar 100 may not be directly coupled to the stator carrier 202 and/or the stator core 204. Instead, the busbar 100 may be indirectly coupled to the stator carrier 202 and/or the stator core 204 via the bus pins 106, the neutral bus 108, the hairpin housings 110, and the temperature sensor housing 112 through the winding 206 to the stator carrier 202 and/or the stator core 204.

The number of the slots in the stator core 204 may be based on the number of hairpins-per-pole-group and the number of poles. For example, the stator core 204 may define seventy-two slots for the winding 206 where the winding 206 is a three-phase winding which defines twelve-poles and two of the hairpins-per-pole-group, although this is not intended to be limiting. Similarly, the number of the hairpins 208 may be based on the number of hairpins-per-pole-group, the number of poles, and the number of layers. For example, the stator core 204 may define seventy-two slots for the winding 206 where the winding 206 is a three-phase winding which defines twelve-poles and two of the hairpins-per-pole-group, although this is not intended to be limiting.

The hairpins 208 may span a select number of slots in the stator core 204. The number of slots in the stator core 204 to which the hairpins 208 span may be based, at least in part, on the number of hairpins-per-pole-group. In particular, the number of slots in the stator core 204 to which the hairpins 208 span may be three times the number of hairpins-per-pole-group. For example, the hairpins 208 may span six of the slots in the stator core 204 where the winding 206 include two of the hairpins-per-pole-group.

The first set of the hairpins 208 and second set of the hairpins 208 may or may not be connected across the layers. For example, the first-phase hairpins 208u of the first set of the hairpins 208 and the second set of the hairpins 208 may be connected across the layers. By way of another example, the second-phase hairpins 208v of the first set of the hairpins 208 and the second set of the hairpins 208 may be connected across the layers. By way of another example, the third-phase hairpins 208w of the first set of the hairpins 208 and the second set of the hairpins 208 may be connected across the layers. In embodiments, the first set of the hairpins 208 and second set of the hairpins 208 may be connected across the layers by a weld, a jumper, or the like.

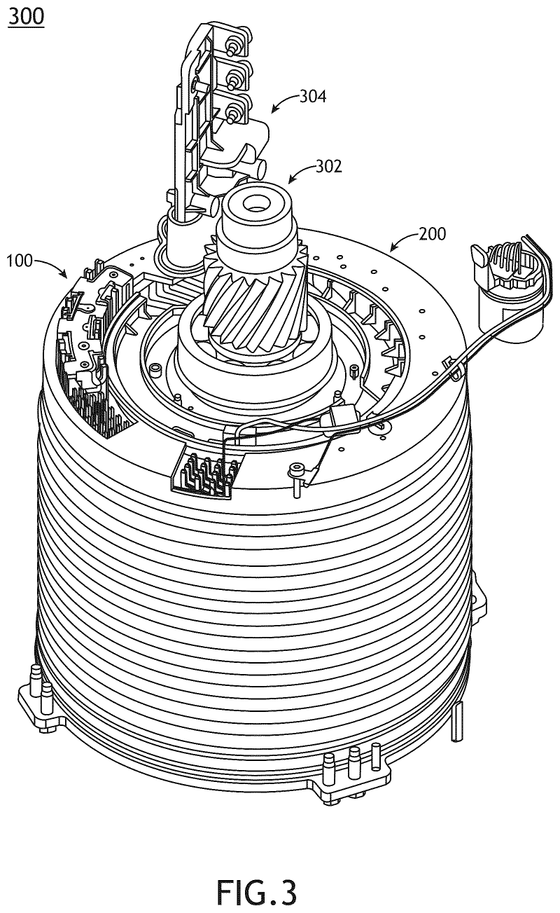

FIG. 3 depicts an electric motor 300, in accordance with one or more embodiments of the present disclosure. The electric motor 300 may be a three-phase electric motor. The electric motor 300 may include the stator 200, a rotor 302, and/or a junction box 304.

The junction box 304 may receive current from one or more external components. For example, the junction box 304 may receive current from an inverter, controller, or the like. The junction box 304 may receive one or more phases of current. The junction box 304 may receive the three phases of current, including the first-phase (u), the second-phase (v), and the third-phase (w).

The junction box 304 may be connected to the busbar 100. The busbar 100 may receive the current from the junction box 304. The bars 104 of the busbar 100 may couple to the junction box 304 for receiving the current. The bus pins 106 may connect to the winding 206. The busbar 100 may distribute the three phases of current to the winding 206. For example, the bus pins 106 may be connected to the winding 206 for distributing the three phases of current. The winding 206 may receive the current from the busbar 100. The winding 206 may induce a magnetic field in response to receiving the three phases of current from the busbar 100.

The rotor 302 may be disposed within the central axis of the stator 200. The rotor 302 may be supported by the stator 200 via one nor more bearings. The magnetic field induced by the winding 206 may cause the rotor 302 to rotate relative to the stator 200. The rotor 302 may perform work on one or more external components via the rotation of the rotor 302. Thus, the electric motor 300 may be a dynamo-electric machine which converts electrical energy to mechanical energy by electromagnetic means.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 busbar
102 overmold
104 bars
104u first-phase bar
104v second-phase bar
104w third-phase bar
106 bus pins
106u first-phase bus pins
106u-1 inner-radius, first-phase bus pins
106u-4 outer-radius, first-phase bus pins
106v second-phase bus pins
106v-1 inner-radius, second-phase bus pins
106v-4 outer-radius, second-phase bus pins
106w third-phase bus pins
106w-1 inner-radius, third-phase bus pins
106w-4 outer-radius, third-phase bus pins
108 neutral bus
110 hairpin housings
110a first hairpin housing
110b second hairpin housing
110c third hairpin housing
110d fourth hairpin housing
112 temperature sensor housing
114 surface
116 blind-holes
118 blind-hole
120 base portion
122 tip portion
200 stator
202 stator carrier
204 stator core
206 winding
207 temperature sensor
208 hairpins
208u first-phase hairpins
208u-1 first-layer, first-phase hairpins
208u-4 fourth-layer, first-phase hairpins
208v second-phase hairpins
208v-1 first-layer, second-phase hairpins
208v-4 fourth-layer, second-phase hairpins
208w third-phase hairpins
208w-1 first-layer, third-phase hairpins
208w-4 fourth-layer, third-phase hairpins
300 electric motor
302 rotor
304 junction box

What is claimed:

1. A busbar comprising:
a plurality of bars;
a plurality of bus pins, wherein the plurality of bus pins are connected to the plurality of bars;
a neutral bus; and
an overmold, wherein the overmold supports the plurality of bars, the plurality of bus pins, and the neutral bus, wherein the overmold defines:
a plurality of hairpin housings, wherein the plurality of hairpin housings define a plurality of blind-holes; and
a temperature sensor housing, wherein the temperature sensor housing defines an additional blind-hole.

2. The busbar of claim 1, wherein the overmold defines a surface, wherein the plurality of hairpin housings and the temperature sensor housing extend from the surface.

3. The busbar of claim 2, wherein the plurality of blind-holes and the additional blind-hole are oriented in parallel, wherein the plurality of blind-holes and the additional blind-hole are orthogonal to the surface.

4. The busbar of claim 3, wherein the additional blind-hole is up to the surface.

5. The busbar of claim 4, wherein the temperature sensor housing comprises a base portion and a tip portion, wherein the base portion extends from the surface, wherein the tip portion extends from the base portion, wherein the additional blind-hole is defined through the base portion and the tip portion up to the surface.

6. The busbar of claim 5, wherein the temperature sensor housing comprises an L-shaped cross-section disposed orthogonal to the surface, wherein the base portion defines a base of the L-shaped cross-section, wherein the tip portion defines a tip of the L-shaped cross-section.

7. The busbar of claim 6, wherein the base portion comprises a rectangular-shaped cross-section which is parallel to the surface, wherein the tip portion comprises a U-shaped cross-section parallel to the surface.

8. The busbar of claim 7, wherein the rectangular-shaped cross-section is a rounded-rectangle.

9. The busbar of claim 6, wherein the temperature sensor housing is taller than the plurality of hairpin housings.

10. The busbar of claim 9, wherein the base portion is taller than the plurality of hairpin housings.

11. The busbar of claim 6, wherein the additional blind-hole is longer than the plurality of blind-holes.

12. The busbar of claim 11, wherein the tip portion defines a first length of the additional blind-hole, wherein a remaining length of the additional blind-hole not defined by the first length is a same length as the plurality of blind-holes.

13. The busbar of claim 6, wherein the plurality of blind-holes and the additional blind-hole are a same width.

14. The busbar of claim 6, wherein the additional blind-hole comprises a draft angle of at least one-degree.

15. The busbar of claim 6, wherein the surface comprises an arcuate shape defining an inner-radius and an outer-radius of the busbar, wherein the tip portion is a radially outermost portion of the temperature sensor housing.

16. The busbar of claim 15, wherein the busbar is a three-phase busbar, wherein the plurality of bars comprise a first-phase bar, a second-phase bar, and a third-phase bar, wherein the plurality of bus pins comprise a plurality of first-phase bus pins, a plurality of second-phase bus pins, and a plurality of third-phase bus pins, wherein the plurality of first-phase bus pins are connected to the first-phase bar, wherein the plurality of second-phase bus pins are connected to the second-phase bar, wherein the plurality of third-phase bus pins are connected to the third-phase bar.

17. The busbar of claim 16, wherein a first set of the plurality of first-phase bus pins, the plurality of second-phase bus pins, and the plurality of third-phase bus pins are disposed along the inner-radius, wherein a second set of plurality of first-phase bus pins, the plurality of second-phase bus pins, and the plurality of third-phase bus pins are disposed along the outer-radius.

18. A stator comprising:
a busbar comprising:
a plurality of bars;
a plurality of bus pins, wherein the plurality of bus pins are connected to the plurality of bars;
a neutral bus; and
an overmold, wherein the overmold supports the plurality of bars, the plurality of bus pins, and the neutral bus, wherein the overmold defines:
a plurality of hairpin housings, wherein the plurality of hairpin housings define a plurality of blind-holes; and
a temperature sensor housing, wherein the temperature sensor housing defines an additional blind-hole;
a stator core;
a winding, wherein the winding is electrically connected to the plurality of bus pins and the neutral bus, the winding comprising a plurality of hairpins, wherein the plurality of hairpins couple to the plurality of hairpin housings and the temperature sensor housing; and
a temperature sensor, wherein the temperature sensor and a pair of the plurality of hairpins are housed within the additional blind-hole, wherein the temperature sensor abuts one of the pair of the plurality of hairpins.

19. The stator of claim 18, wherein the overmold defines a surface, wherein the plurality of hairpin housings and the temperature sensor housing extend from the surface, wherein the plurality of blind-holes and the additional blind-hole are oriented in parallel, wherein the plurality of blind-holes and the additional blind-hole are orthogonal to the surface, wherein the temperature sensor housing comprises a base portion and a tip portion, wherein the base portion extends from the surface, wherein the tip portion extends from the base portion, wherein the additional blind-hole is defined through the base portion and the tip portion up to the surface, wherein the temperature sensor is disposed within a portion of the additional blind-hole defined by the tip portion.

20. An electric motor comprising:
a stator comprising:
a busbar comprising:
a plurality of bars;
a plurality of bus pins, wherein the plurality of bus pins are connected to the plurality of bars;
a neutral bus; and
an overmold, wherein the overmold supports the plurality of bars, the plurality of bus pins, and the neutral bus, wherein the overmold defines:
a plurality of hairpin housings, wherein the plurality of hairpin housings define a plurality of blind-holes; and
a temperature sensor housing, wherein the temperature sensor housing defines an additional blind-hole;
a stator core;
a winding, wherein the winding is electrically connected to the plurality of bus pins and the neutral bus, the winding comprising a plurality of hairpins, wherein the plurality of hairpins couple to the plurality of hairpin housings and the temperature sensor housing; and
a temperature sensor, wherein the temperature sensor and a pair of the plurality of hairpins are housed within the additional blind-hole, wherein
the temperature sensor abuts one of the pair of the plurality of hairpins;
a junction box coupled to the plurality of bars; and
a rotor disposed within a central axis of the stator.
